(19) United States
(12) Patent Application Publication
(10) Pub. No.: US 2026/0213328 A1
(43) Pub. Date: Jul. 23, 2026

(54) VARIABLE BATTERY CAP ASSEMBLY

(71) Applicant: WILCOX INDUSTRIES CORP., Newington, NH (US)

(72) Inventor: Gary M. Lemire, Lee, NH (US)

(21) Appl. No.: 19/384,522

(22) Filed: Nov. 10, 2025

Related U.S. Application Data
(60) Provisional application No. 63/747,317, filed on Jan. 20, 2025.

(51) Int. Cl. H01M 50/271; H01M 50/202; H01M 50/267; H01M 50/588; H01M 50/593; H01M 50/107

(52) U.S. Cl. CPC H01M 50/271; H01M 50/202; H01M 50/267; H01M 50/588; H01M 50/593; H01M 50/107

(57) ABSTRACT

A battery cap assembly is configured to be coupled to an open end of a battery tube and includes a main cap member receiving a threaded journal. A threaded power contact has threads which engage complementary threads on the threaded journal. Rotation of the threaded power contact in a first direction is configured to cause movement of the threaded power contact relative to the threaded journal in a first axial direction. Rotation of the threaded power contact in a second direction opposite the first direction is configured to cause movement of the threaded power contact in a second axial direction opposite the first axial direction. A knob is rotatably coupled to the main cap member and includes a first drive feature engaging a second drive feature on the threaded power contact to transmit rotational motion from the knob to the threaded power contact.

### CROSS REFERENCE TO RELATED APPLICATION

This application claims the priority benefit of U.S. provisional application no. 63/747,317 filed January 20, 2025. The aforementioned application is incorporated herein by reference in its entirety.

### BACKGROUND

The present disclosure relates to batteries and, more particularly, to a battery cap assembly used therefor to reduce or eliminate the effects of battery bounce. The present development is advantageously used for battery operated devices which may experience mechanical forces, such as a device attached to a weapon accessory that experiences recoil forces. However, it will be recognized that the present development is also amenable for use in connection with all manner of other devices

Many portable electronic devices are powered by removable batteries that are coupled to electrical or electronic circuits with mechanical coupling between electrical contacts, such as spring loaded electrical contacts. The use of removable batteries is useful because it simplifies battery replacement. However, because of the mechanical contacts, the battery can lose electrical contact when the device is subject to mechanical shock, resulting in a momentary interruption of power to these circuits. Such interruption of power is undesirable, since it can result in the electronic device shutting down or going through a reboot cycle, thereby resulting in a loss of functionality while the unit reboots. For devices used in critical situations, such as war fighting scenarios, even temporary loss of functionality of the device during the time it takes the device to reboot can be catastrophic. In addition, sudden interruptions in power can also corrupt files or system configurations, potentially leading to the need for more extensive recovery efforts.

One method for mitigating battery bounce is to include back up circuitry such as a back up battery and/or a capacitor to maintain power during a battery bounce condition. However, such additional components increase the size, expense, and complexity of the device.

Another method for mitigating battery bounce is to “hard fix” the distance of battery travel under certain conditions such as weapon recoil. However, although standard battery sizes exist, such as AA (e.g., LR6), AAA (e.g., LR03), among many others, current battery industry standards lack stringent dimensional tolerancing and variations in length are frequently observed among batteries of the same nominal size produced by different manufacturers. Thus, hard fixing the distance of battery travel under shock force or mechanical impact conditions such as weapon recoil is not sufficient to eliminate battery bounce unless it is designed for exclusive use with a specific battery manufacturer’s product. However, this approach limits the device’s applicability, since a given manufacturer’s battery product may not be readily available in all regions, for example, as a result of distribution limitations or supply chain constraints.

The present disclosure contemplates a new and improved variable battery cap apparatus, battery tube assembly, and method which overcome the above-referenced problems and others.

### SUMMARY

In one aspect, a battery cap assembly is configured to be coupled to an open end of a battery tube. The battery cap assembly includes a main cap member receiving a threaded journal. A threaded power contact has helical threads which engage complementary helical threads on the threaded journal. Rotation of the threaded power contact in a first direction is configured to cause movement of the threaded power contact relative to the threaded journal in a first axial direction. Rotation of the threaded power contact in a second direction opposite the first direction is configured to cause movement of the threaded power contact in a second axial direction opposite the first axial direction. A knob is rotatably coupled to the main cap member and includes a first drive feature engaging a second drive feature on the threaded power contact to transmit rotational motion from the knob to the threaded power contact.

In a preferred, more limited aspect, the threaded power contact comprises one or more external threads configured to engage one or more complementary internal threads on the threaded journal.

In a more limited aspect, the threaded power contact is configured to engage a positive terminal of a battery received within the battery tube assembly.

In a more limited aspect, the threaded power contact is configured to move within a range configured to accommodate variations in battery length of batteries from different manufacturers.

In another more limited aspect, the knob is a manually rotatable knob disposed on an exterior side of the main cap member, the manually rotatable knob including a keyed drive feature engaging a complementary receptacle formed on the threaded power contact.

In another more limited aspect, the main cap member comprises a core being formed of a conductive material and an overmolded collar being formed of a polymeric material.

In another more limited aspect, the overmolded collar is disposed about at least a portion of the conductive core and the overmolded collar is disposed intermediate the manually rotatable knob and the core.

In another more limited aspect, the battery cap assembly further comprises a sealing ring received within an outer annular groove formed in an exterior-facing wall of the core.

In another more limited aspect, the threaded journal comprises a neck and a base flange. The core has a first opening at a first end configured to receive the base flange and an inwardly extending flange defining a second opening configured to receive the neck therethrough.

In another more limited aspect, the battery cap assembly further comprises an insulator disc formed of an electrically insulating material disposed within the core, the insulator disc disposed adjacent the threaded power contact. The insulator disc has a central opening configured to permit insertion of a battery terminal of a correct polarity while maintaining a spacing between the threaded power contact and a battery terminal of an opposite polarity.

In another more limited aspect, a variable battery cap assembly in combination with the battery tube assembly is provided.

In a more limited aspect, the combination is configured for use in a device selected from the group consisting of a fire control system, a laser aiming device, an optical range finder, a night vision device, and a thermal camera, and combinations thereof.

In another more limited aspect, the battery tube assembly comprises a tube body configured to receive a cylindrical battery having a first terminal disposed at a first axial end thereof and as second terminal disposed at a second axial end thereof opposite the first axial end.

In another more limited aspect, the tube body comprises a proximal end having an inwardly extending flange defining a reduced diameter opening and an open distal end configured to receive the battery.

In another more limited aspect, the main cap member has an open end configured to rotatably engage the open distal end of the tube body.

In another more limited aspect, the proximal end comprises a passage configured to receive a lead wire for electrically coupling the lead wire to a circuit.

In another more limited aspect, the lead wire is a negative lead wire.

In another more limited aspect, the combination further comprises a plug member received within the tube body. The plug member comprises an outwardly extending flange engaging the inwardly extending on the tube body and an axially-extending portion extending through the reduced diameter opening.

In another more limited aspect, the combination further comprises an electrical contact disposed on the plug and a passageway formed in the plug, the passageway configured to receive a lead wire or electrical coupling to the electrical contact.

In another more limited aspect, the combination further comprises a sealing member received within a circumferential groove formed on the on the outwardly extending flange configured to provide a sealing interference between the plug member and an inner wall of the tube body.

In another more limited aspect, the combination further comprises an elastomeric ring seated against the outwardly extending flange and configured to generate a resilient biasing force against the battery when the battery is received within the tube body.

In another more limited aspect, the tube body includes an outer surface having one or more external threads and one or more locking lands and the main cap member comprises one or more inwardly extending tabs. The one or more inwardly extending tabs are configured to ride along the one or more external threads during engagement of the main cap member with the tube body and to engage the one or more locking lands to maintain the main cap member in a secured position.

In another more limited aspect, at least one of the one or more locking lands and/or at least one or more of the inwardly extending tabs includes a ramped leading edge configured to facilitate engagement of the one or more inwardly extending tabs with the one or more locking lands during rotation of the main cap member relative to the tube body.

In another aspect, a method for reducing or preventing battery bounce in a battery tube assembly is provided.

Various advantages and benefits of the present development will become apparent to those of ordinary skill in the art upon reading and understanding the following detailed description of the preferred embodiment(s).

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of an exemplary electronic device employing a variable battery cap and associated battery tube assembly in accordance with the present disclosure.

FIG. 2 is an isometric view of an exemplary battery tube assembly with the variable battery cap.

FIG. 3 is an exploded isometric view of the battery tube assembly and variable battery cap appearing in FIG. 2.

FIG. 4 is an exploded isometric view of the variable battery cap.

FIG. 5 is an enlarged isometric view of the variable battery cap.

FIG. 6 is a side view of the exemplary battery tube assembly and variable battery cap appearing in FIG. 2.

FIG. 7 is a side cross-sectional view taken along the lines 7--7 appearing in FIG. 6.

FIG. 8 is an enlarged partial view of the side cross-sectional view appearing in FIG. 7.

### DETAILED DESCRIPTION OF THE PREFERRED EMBODIMENT(S)

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

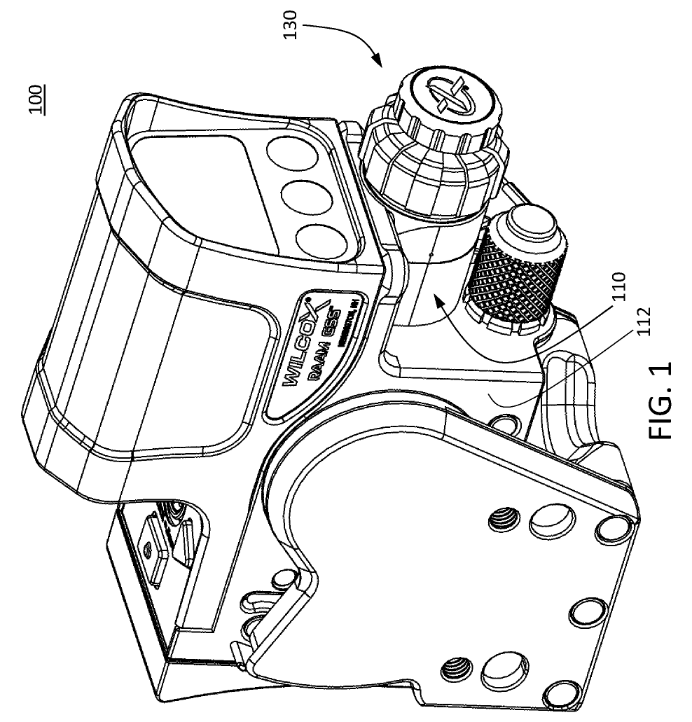

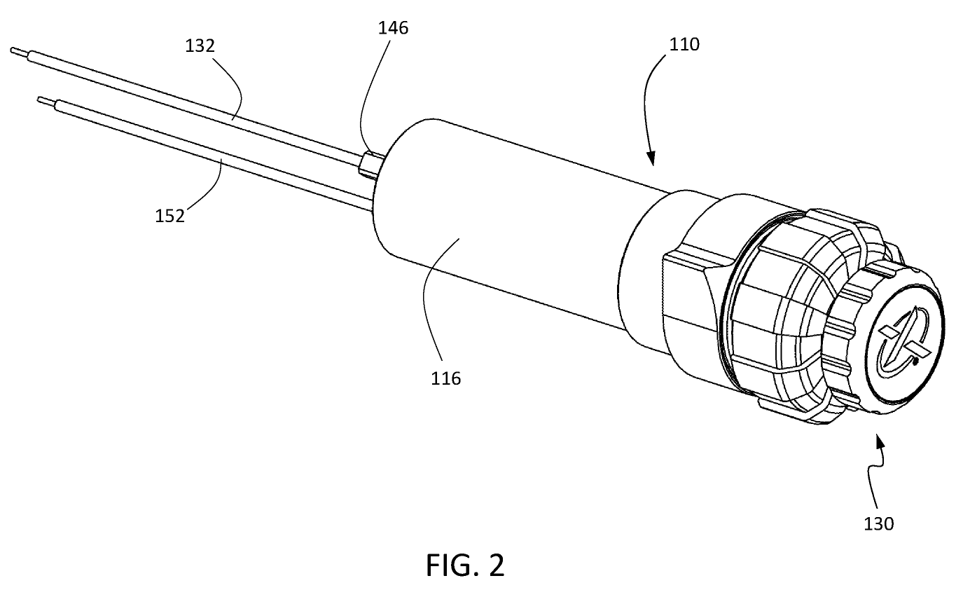

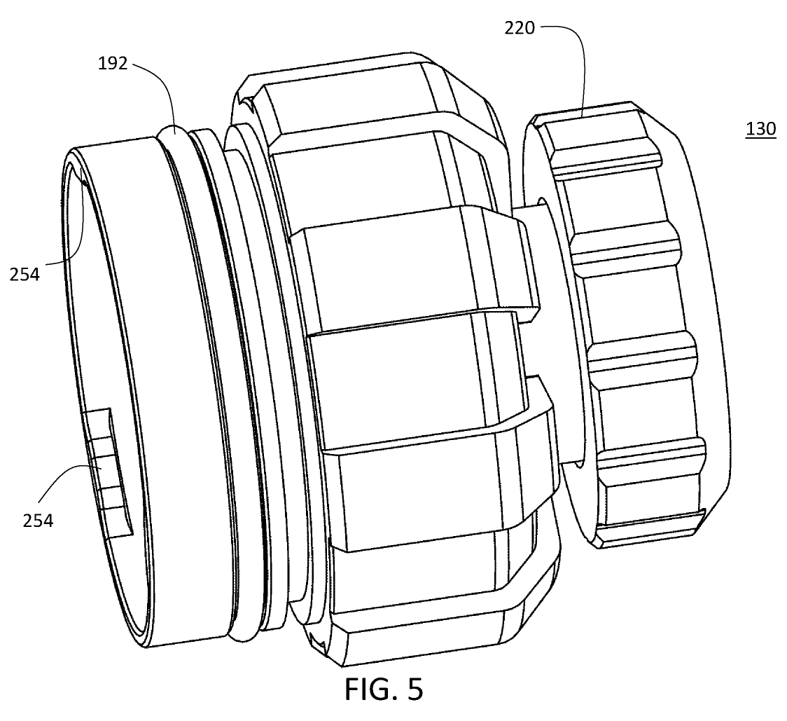

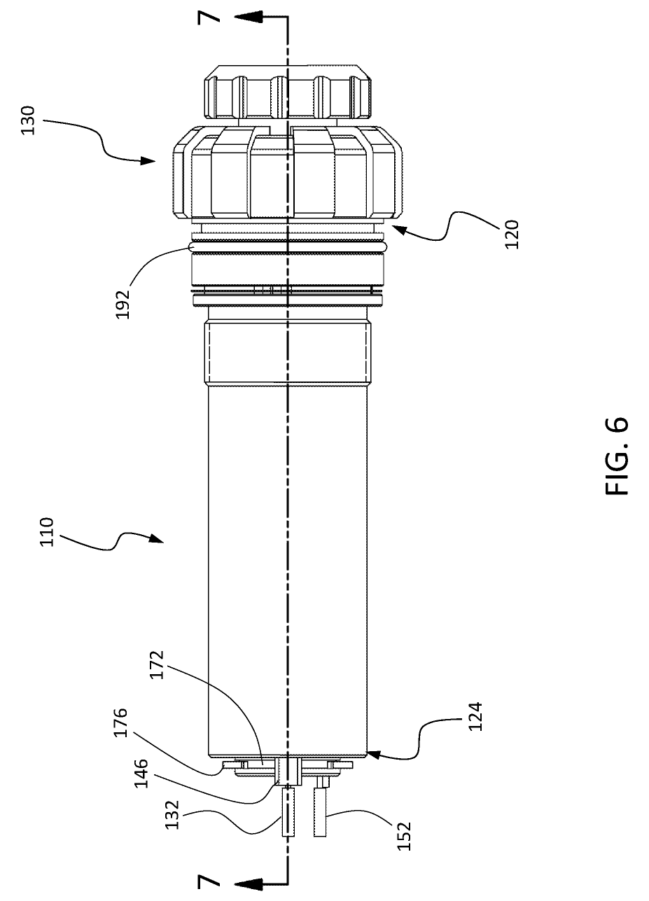

Referring now to the drawing FIGS. 1-7, there is shown a battery operated portable electronic device 100 which is powered by a battery 104, which is received within a battery tube assembly 110. Although the electronic device 100 may be any battery-powered portable electronic device, it is advantageously a device which is expected to experience mechanical forces during use, such as battery powered weapon-mounted accessory devices which frequently experience recoil forces during operation when the weapon is fired. The device 100 in the illustrated embodiment is a Wilcox Rapid Acquisition Aiming Module - Grenadier Sighting System (RAAM-GSS) fire control system available from Wilcox Industries Corp. of Newington, New Hampshire, USA. Other types of electronic devices include laser aiming devices, optical range finders, night vision devices, thermal cameras, and others.

The device 100 includes a housing 112 which receives the battery tube assembly 110. The battery tube assembly 110 includes a tube body 116 forming an interior compartment receiving the battery 104. The battery tube assembly 110 has a first end 120 and a second end 124. The tube assembly 110 is open at the first end 120 to allow for insertion and removal of the battery 104. The open end 120 is configured to be closed by a removable variable battery cap assembly 130.

A positive lead 132 is in electrical communication with a positive power contact 136. The positive power contact 136 is formed of a conductive material, such as brass or other metal. The positive lead 132 may be electrically coupled to the positive power contact 136 via a threaded journal 200, as described below, and one or more conductive elements received within the battery tube assembly 110. The positive power contact 136 includes a contact pad portion 140 at one end which is configured to engage a positive terminal 144 on the battery. The positive power contact 136 further includes a threaded shaft portion 148. The end of the threaded shaft portion 148 opposite the contact pad portion 140 includes a keyed geometric drive feature 150.

In certain embodiments, the end of the tube body 116 adjacent to the second end 124 of the tube assembly 110 includes an inwardly extending flange 142 defining a reduced diameter opening. In embodiments, a boss 146 extends axially from the second end 124 of the tube assembly 110. The boss 146 includes a bore which provides a via for passage of the positive lead between the interior of the housing 112 and the battery tube assembly 110.

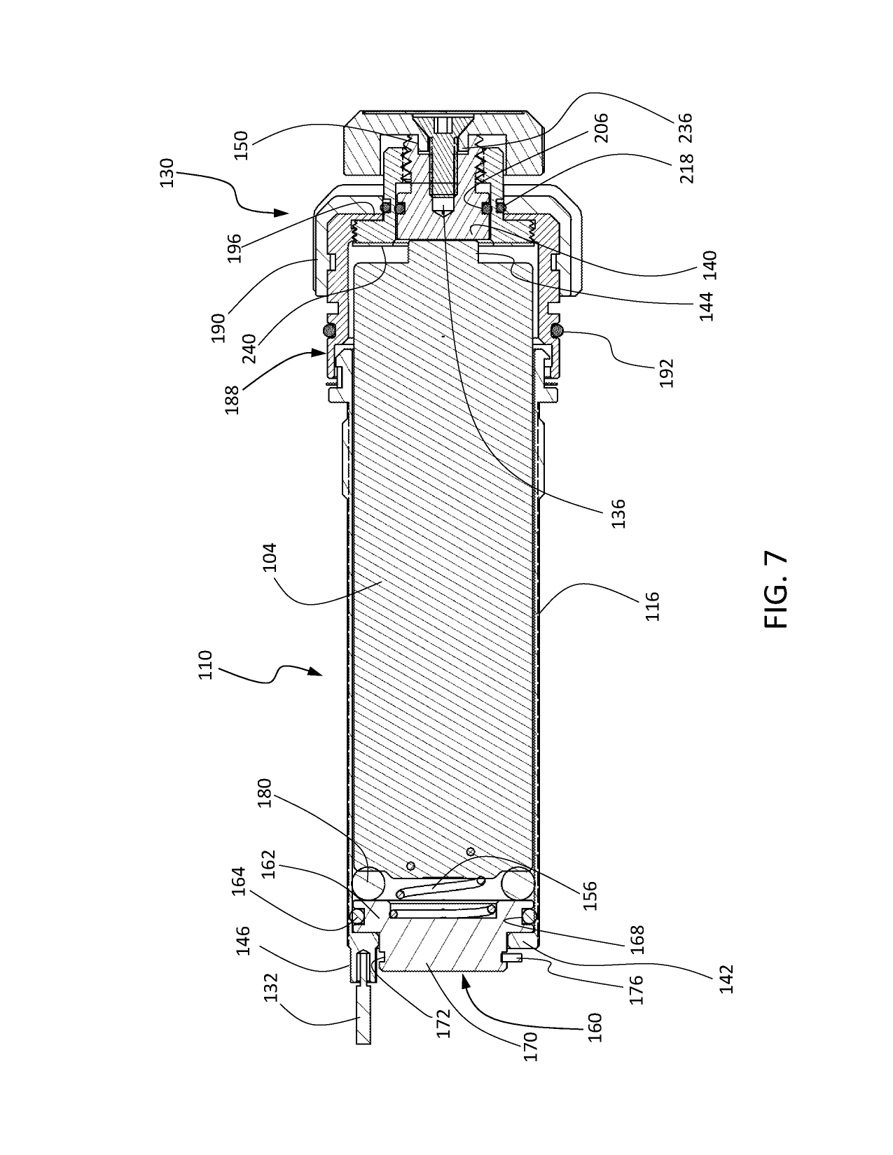

A negative lead 152 is in electrical communication with a negative power contact 156 (see FIG. 7) disposed within the tube body 116 and positioned near the second end 124 of the tube assembly 110. In embodiments, the negative power contact 156 comprises a conical coil spring. In embodiments, the lead 152 passes through an opening 155 in the plug member 160. In embodiments, the plug member 160 is formed of an electrically insulating material. The negative power contact 156, in turn, is configured to contact a negative terminal 154 on the battery 104. The second end 124 of the tube assembly 110 is closed with a plug member 160 received within the tube body 116. The plug member 160 includes an outwardly extending flange 162 which engages the inward flange 142 on the tube body 116. A sealing ring or gasket 164, which may be formed of an elastomer or other resilient material, is received within a circumferential groove 168 on the flange 162 to provide a sealing interference between the plug member 160 and the inner wall of the tube body 116 to prevent moisture or other contamination from passing between the tube assembly 110 and the interior of the housing 112 of the electronic device 100.

In embodiments, the plug 160 includes an axially-extending portion 170 which passes through the opening defined by the inward flange 142, the axially-extending portion 170 having an annular groove 172. In embodiments, the axially-extending portion 170 extends through a complementary opening (not shown) within the housing 112, such as an opening formed in an internal wall or partition within the housing 112. In embodiments, a spring clip or retaining ring 176 is received within the annular groove 172 to axially retain the tube assembly 110 within the housing 112 and/or to retain the plug member 160 within the tube body 116. In embodiments, the boss 146 passes through a complementary notch or opening (not shown), e.g., on the periphery of an opening within the device housing 112 that receives the axially-extending portion 170, to provide rotational indexing and rotationally affix the tube assembly 110 with respect to the housing 112.

Within the interior of the tube body 116, an elastomeric ring 180 is seated between the end of the battery 104 that is adjacent to the second end 124 of the tube assembly 110 and the flange 162. When the tube assembly 110, battery 104, and the cap assembly 130 are assembled, axial compression of the elastomeric ring 180 generates a resilient force, urging the flange 162 to seat firmly against the inward flange 142. In addition, the axial compression of the elastomeric ring 180 generates a resilient force urging the positive terminal 144 of the battery 104 to bear against the contact 140 to thereby mitigate the potential for loss of electrical contact as a result of battery bounce conditions, such as weapon recoil or other sudden forces.

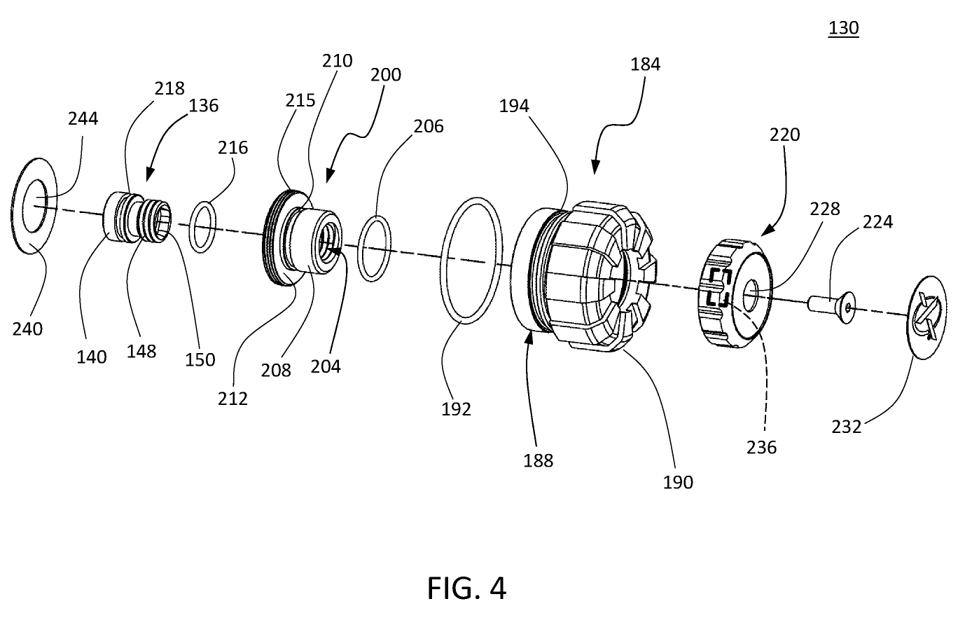

As best seen in FIG. 4, the battery cap assembly 130 includes a main cap member 184 which includes a core 188 and a gripping collar 190. In embodiments, the main cap member 184 is formed of a conductive, e.g., brass, core 188 wherein the gripping collar 190 is formed of a polymer material which is overmolded onto the brass core 188. An elastomeric sealing ring or gasket 192 is disposed within an external annular groove 194 to provide a sealing interference between the cap assembly 130 and the housing 112 to prevent moisture or external contamination from entering therebetween.

The core 188 includes a first open end which is configured to rotationally engage the first end 120 of the battery tube assembly 110 as described below. An inwardly extending flange 196 at a second end of the core 188 defines reduced diameter opening.

The main cap member 184 receives the threaded journal 200 on an interior side thereof, which may be formed of brass or other metal. The illustrated threaded journal 200 includes an internally threaded bore 204, a neck 208, and a base flange 212 extending radially outward from the neck 208. The neck 208 extends through the reduced diameter opening defined by the inward flange 196. The base flange 212 engages the inward flange 196. An elastomeric sealing ring or gasket 206 is disposed within an annular channel 210 formed on the neck 208.

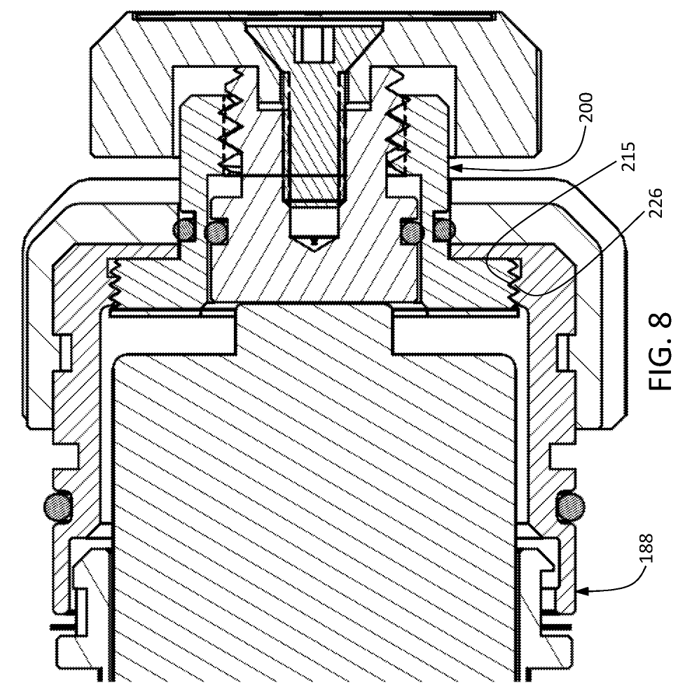

In embodiments, as best seen in FIGS. 4 and 8, helical threads 215 are formed on the peripheral edge of the base flange 212. The helical threads 215 engage complementary internal helical threads 226 formed in the core 188 for securing the core to the threaded journal

The external threads 148 on the threaded power contact 136 threadably engage the internal threads of the internally threaded bore 204. In this manner, the threaded journal 200 and the threaded power contact 136 operate as a unit, wherein the axial position of the contact pad 140 can be advanced toward the battery 104 by rotating the threaded power contact 136 relative to the threaded journal 200 in one direction, or, away from the battery 104 by rotating the threaded power contact 136 relative to the threaded journal 200 in the opposite direction. In this manner, the position of the power contact 136 can be adjusted to accommodate variations in battery length in batteries from different manufacturers while providing sufficient compression to prevent loss of electrical contact due to battery bounce resulting from recoil forces or other mechanical shock. An elastomeric sealing ring or gasket 216 is disposed within an annular channel 218 formed on the threaded power contact 136. Although the illustrated embodiment depicts the core 188 as having an internally threaded bore 204 engaging external threads 148 on the threaded power contact 136, in alternative embodiments (not shown), the internally threaded bore 204 can be replaced with an externally threaded member and the external threads 148 on the threaded power contact 136 can be replaced a complementary, internally threaded bore.

A power contact tensioning drive knob 220 is disposed on an exterior side of the main cap member 184. A threaded fastener 224 passes through an axial opening 228 in the power contact tensioning drive knob 220 and threadably engages a blind axial bore 230 in the threaded power contact 136. A cap or label 232 may be provided on the exterior surface of the drive knob 220 to cover the fastener 224 and the opening 228 and may have indicia such as a logo or other material printed thereon. A keyed geometric drive feature 236 is disposed on the power contact tensioning drive knob 220 and is complementary with the keyed geometric drive feature 150 on the threaded power contact 136. The keyed geometric drive features 150 and 236 are configured to engage with one another to allow the transfer torque when the power contact tensioning drive knob 220 is rotated to selectively advance or retract the threaded power contact 136 in relation to the threaded journal 200. In embodiments, an insulator disc 240 formed of an electrically insulating material is disposed within the core 188 to provide reverse polarity protection. The disc 240 includes a central opening 244 sized to accommodate the positive battery contact 144. In the illustrated preferred embodiment depicting an “AA” size battery 104, the central opening 244 is large enough to allow the positive terminal 144 (which defines a raised protrusion that is generally smaller in diameter than the negative terminal 154) to pass through the opening 244 and contact the contact pad 140. The disc 240 prevents the negative terminal (which is generally flat and extends over a substantially larger portion of the diameter of the battery than the protruding positive terminal positive 144) from contacting the contact pad 140 in the event a battery is inserted into the battery tube assembly 110 in the reverse orientation.

It will be recognized that in alternative embodiments, the battery tube assembly 110 may be configured to receive the battery 104 with the positive terminal positioned “in” toward the first end 120 and the negative terminal positioned “out,” such that the orientation of the battery terminals 144, 154 is reversed relative to the illustrated embodiment. Such embodiments maintain the same functional interaction between the cap assembly 130 and the battery 104 to prevent battery bounce with a reverse terminal orientation of the battery tube assembly 110, e.g., in accordance with the polarity requirements of the circuit.

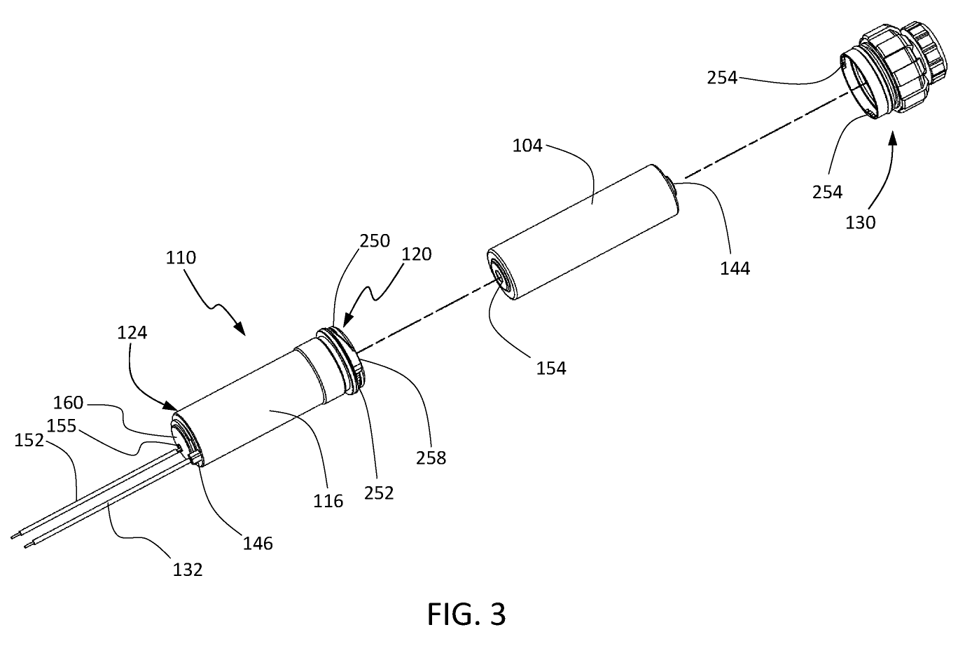

A rotational or twist-on connection is provided between the battery cap assembly 130 and the open end of the battery tube assembly 110. In embodiments, a quick lock feature is provided. As best seen in FIG. 3, in certain embodiments the open end of the battery tube body 116 includes a plurality (three in the illustrated embodiment) of helical tensioning ramps, threads, or ridges 250 which are angularly offset from each other (spaced approximately 120 degrees apart in the depicted embodiment). A corresponding plurality (three in the depicted embodiment) of locking lands 252 are likewise angularly offset from each other (spaced approximately 120 degrees apart in the depicted embodiment). A corresponding plurality (three in the depicted embodiment) of gaps 258 between the ramps 250 and the locking lands 252 are likewise angularly offset from each other (spaced approximately 120 degrees apart in the depicted embodiment) and provide a lead in feature to guide engagement between the cap assembly 130 and the tube assembly 110.

The core portion 188 of the main cap member 184 includes a plurality of locking tabs 254 (three in the depicted embodiment) angularly offset from each other (spaced approximately 120 degrees apart in the depicted embodiment). In operation, the cap assembly 130 is positioned over the open end of the tube body 116 and rotated such that the ramps 250 tension the locking tabs 254 move downward until they engage with the locking lands 252 to resist axially outward movement of the cap assembly 130 in relation to the battery tube assembly 110. In embodiments, ramped or inclined surfaces on leading edges may be provided on the locking tabs 254 and/or locking lands 252 to facilitate sliding movement there past. Although the illustrated embodiment depicts the rotational engagement feature on the core portion 188 as being a plurality of spaced apart tabs 254, it will be recognized that other rotational engagement features are also contemplated such as one or more continuous or segmented internal helical threads. In alternative embodiments, the core 188 may be provided with bayonet-style projections configured that engage complementary features on the tube assembly 110.

In the illustrated embodiment, locking and unlocking can be accomplished in 1/3 of a turn. Other embodiments are contemplated. For example, a quarter turn configuration could be provided using four tensioning ramps 250 spaced 90 degrees apart, four locking lands 252 spaced 90degrees apart, and four locking tabs 254 spaced 90 degrees apart. As another example, a half turn configuration could be provided using two tensioning ramps 250 spaced 180 degrees apart, two locking lands 252 spaced 180 degrees apart, and two locking tabs 254 spaced 180degrees apart.

In the illustrated embodiment, the keyed geometric drive feature 150 is a square drive receptacle and the keyed geometric drive feature 236 is a complementary male square drive feature. However, it will be recognized that the keyed geometric drive feature 150 may take the form of a keyed protrusion or a keyed receptacle, while the keyed geometric drive feature 236 may take the form of a complementary keyed drive receptacle or keyed protrusion, respectively. Alternative keyed drive features are contemplated, including star drive, hex drive, and other keyed geometric configurations.

Although the illustrated embodiment depicts a variable battery cap assembly 130 and battery tube assembly 110 which are configured for a AA size battery, it will be recognized that the present invention can be adapted for use with standard size cylindrical batteries, including but not limited to AAA, C, D, CR123A, RCR123A 18650, 14500, 16340, 16650, 26650, 21700, 10440, 17670, 18490, 17500, 17335, and 22500 size batteries.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A battery cap assembly configured to be coupled to an open end of a battery tube, the battery cap assembly comprising:
a main cap member receiving a threaded journal;
a threaded power contact having helical threads which engage complementary helical threads on the threaded journal, wherein rotation of the threaded power contact in a first direction is configured to cause movement of the threaded power contact relative to the threaded journal in a first axial direction and wherein rotation of the threaded power contact in a second direction opposite the first direction is configured to cause movement of the threaded power contact in a second axial direction opposite the first axial direction;
a knob rotatably coupled to the main cap member, the knob including a first drive feature engaging a second drive feature on the threaded power contact to transmit rotational motion from the knob to the threaded power contact.

2. The battery cap assembly of claim 1, wherein the threaded power contact comprises one or more external threads configured to engage one or more complementary internal threads on the threaded journal.

3. The battery cap assembly of claim 1, wherein the threaded power contact is configured to contact a positive terminal of a battery received in the battery tube.

4. The battery cap assembly of claim 1, wherein the threaded power contact is configured to move within a range configured to accommodate variations in battery length of batteries from different manufacturers.

5. The battery cap assembly of claim 1, wherein the knob is a manually rotatable knob disposed on an exterior side of the main cap member, the manually rotatable knob including a keyed drive feature engaging a complementary receptacle formed on the threaded power contact.

6. The battery cap assembly of claim 5, further comprising:
the main cap member comprising a core being formed of a conductive material and an overmolded collar being formed of a polymeric material.

7. The battery cap assembly of claim 6, further comprising:
the overmolded collar being disposed about at least a portion of the conductive core; and
the overmolded collar disposed intermediate the manually rotatable knob and the core.

8. The battery cap assembly of claim 6, further comprising:
a sealing ring received within an outer annular groove formed in an exterior-facing wall of the core.

9. The battery cap assembly of claim 6, further comprising:
the threaded journal having a neck and a base flange;
the core having a first opening at a first end configured to receive the base flange;
the core further comprising an inwardly extending flange defining a second opening configured to receive the neck therethrough.

10. The battery cap assembly of claim 6, further comprising:
an insulator disc formed of an electrically insulating material disposed within the core, the insulator disc disposed adjacent the threaded power contact; and
the insulator disc having a central opening configured to permit insertion of a battery terminal of a correct polarity while maintaining a spacing between the threaded power contact and a battery terminal of an opposite polarity.

11. The battery cap assembly of claim 1, in combination with the battery tube assembly.

12. The combination of claim 11, wherein the combination is configured for use in a device selected from the group consisting of a fire control system, a laser aiming device, an optical range finder, a night vision device, and a thermal camera, and combinations thereof.

13. The combination of claim 11, wherein the battery tube assembly comprises:
a tube body configured to receive a cylindrical battery having a first terminal disposed at a first axial end thereof and as second terminal disposed at a second axial end thereof opposite the first axial end.

14. The combination of claim 13, wherein the tube body comprises:
a proximal end having an inwardly extending flange defining a reduced diameter opening; and
an open distal end configured to receive the battery.

15. The combination of claim 14, further comprising:
said main cap member having an open end configured to rotatably engage the open distal end of the tube body.

16. The combination of claim 14, wherein the proximal end comprises a passage configured to receive a lead wire for electrically coupling the lead wire to a circuit.

17. The combination of claim 16, wherein the lead wire is a negative lead wire.

18. The combination of claim 14, further comprising a plug member received within the tube body, the plug member comprising:
an outwardly extending flange engaging the inwardly extending on the tube body; and
an axially-extending portion extending through the reduced diameter opening.

19. The combination of claim 14, further comprising:
an electrical contact disposed on the plug; and
a passageway formed in the plug, the passageway configured to receive a lead wire or electrical coupling to the electrical contact.

20. The combination of claim 19, further comprising a sealing member received within a circumferential groove formed on the on the outwardly extending flange configured to provide a sealing interference between the plug member and an inner wall of the tube body.

21. The combination of claim 19, further comprising:
an elastomeric ring seated against the outwardly extending flange and configured to generate a resilient biasing force against the battery when the battery is received within the tube body.

22. The combination of claim 14, further comprising:
the tube body having an outer surface having one or more external threads and one or more locking lands;
the main cap member comprising one or more inwardly extending tabs, the one or more inwardly extending tabs being configured to ride along the one or more external threads during engagement of the main cap member with the tube body and to engage the one or more locking lands to maintain the main cap member in a secured position.

23. The combination of claim 22, wherein at least one of the one or more locking lands and/or at least one or more of the inwardly extending tabs includes a ramped leading edge configured to facilitate engagement of the one or more inwardly extending tabs with the one or more locking lands during rotation of the main cap member relative to the tube body.
